(19) United States
(12) Patent Application Publication
(10) Pub. No.: US 2025/0305644 A1
(43) Pub. Date: Oct. 2, 2025

(54) METHODS AND INTERNET OF THINGS (IOT) SYSTEMS FOR PIPELINE IMPURITY MONITORING BASED ON INTELLIGENT GAS IOT

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Junyan ZHOU, Chengdu (CN); Feng WANG, Chengdu (CN)

(73) Assignee: CHENGDU QINCHUAN IOT TECHNOLOGY CO., LTD., Chengdu (CN)

(21) Appl. No.: 19/235,560

(22) Filed: Jun. 11, 2025

(30) Foreign Application Priority Data
Mar. 25, 2025 (CN) 202510352836.6

(51) Int. Cl. F17D 5/00; G05B 13/02; G06Q 30/018; G06Q 50/26

(52) U.S. Cl. CPC F17D 5/005; G05B 13/028; G06Q 30/018; G06Q 50/265

(57) ABSTRACT

A method and an IoT system for pipeline impurity monitoring based on an intelligent gas IoT are provided. The IoT system includes a government safety monitoring and management platform, a government safety monitoring sensor network platform, a government safety monitoring object platform including a gas company management platform, a gas company sensor network platform, and a gas device object platform. The gas company management platform is configured to obtain pressure monitoring data and temperature monitoring data of a valve device, determine an impurity aggregation degree of at least one gas pipeline based on the pressure monitoring data and the temperature monitoring data, receive an impurity removal instruction and determine a temperature adjustment parameter based on the impurity removal instruction and the impurity aggregation degree, receive a confirmation parameter, generate a temperature adjustment instruction based on the confirmation parameter, and send the temperature adjustment instruction to a temperature control device.

### CROSS-REFERENCE TO RELATED APPLICATIONS

The present disclosure claims priority to Chinese Patent Application No. 202510352836.6, filed on Mar. 25, 2025, the entire contents of which are hereby incorporated by reference.

### TECHNICAL FIELD

The present disclosure relates to the field of pipeline impurity monitoring, and in particular, to methods and Internet of Things (IoT) systems for pipeline impurity monitoring based on an intelligent gas IoT.

### BACKGROUND

Gas is mainly transported through pipelines. During transportation, secondary non-gas impurities are generated in the pipeline. These impurities may be deposited on the inner wall of the pipeline due to changes in pipeline structure, temperature, or pressure. The presence of non-gas impurities may not only corrode the pipeline locally, leading to safety hazards, but also adversely affect the operational safety and regulatory stability of pipeline appurtenances (e.g., valves, monitoring devices, etc.).

Therefore, it is desired to provide a method and an Internet of Things (IoT) system for pipeline impurity monitoring based on an intelligent gas IoT, which may monitor the accumulation of impurities in gas pipelines in real-time and accurately. This enables the timely detection and effective handling of pipeline corrosion issues, thereby ensuring the overall safety performance of gas pipelines.

### SUMMARY

One or more embodiments of the present disclosure provide an Internet of Things (IoT) system for pipeline impurity monitoring based on an intelligent gas IoT. The IT system may include a government safety monitoring and management platform, a government safety monitoring sensor network platform, a government safety monitoring object platform, a gas company sensor network platform, and a gas device object platform. The gas device object platform may include a valve device and a temperature control device deployed at at least one pipeline connection, and the valve device includes a pressure monitoring component and a temperature monitoring component. The government safety monitoring object platform may include a gas company management platform and a key gas-using company. The gas company management platform may be configured to obtain pressure monitoring data and temperature monitoring data of the valve device from the gas device object platform via the gas company sensor network platform; determine an impurity aggregation degree of at least one gas pipeline based on the pressure monitoring data and the temperature monitoring data and send the impurity aggregation degree to the government safety monitoring and management platform via the government safety monitoring sensor network platform; receive an impurity removal instruction sent by the government safety monitoring and management platform, determine a temperature adjustment parameter based on the impurity removal instruction and the impurity aggregation degree, and send the temperature adjustment parameter to the government safety monitoring and management platform; and receive a confirmation parameter returned by the government safety monitoring and management platform, generate a temperature adjustment instruction based on the confirmation parameter, and send the temperature adjustment instruction to the temperature control device via the gas company sensor network platform and the gas device object platform.

One or more embodiments of the present disclosure provide a method for pipeline impurity monitoring based on an intelligent gas IoT. The method may be executed by a gas company management platform of an IoT system for pipeline impurity monitoring based on an intelligent gas IoT. The method may include obtaining pressure monitoring data and temperature monitoring data of a valve device from a gas device object platform via a gas company sensor network platform; determining an impurity aggregation degree of at least one gas pipeline based on the pressure monitoring data and the temperature monitoring data and sending the impurity aggregation degree to a government safety monitoring and management platform via a government safety monitoring sensor network platform; receiving an impurity removal instruction sent by the government safety monitoring and management platform, determining a temperature adjustment parameter based on the impurity removal instruction and the impurity aggregation degree, and sending the temperature adjustment parameter to the government safety monitoring and management platform; and receiving a confirmation parameter returned by the government safety monitoring and management platform, generating a temperature adjustment instruction based on the confirmation parameter, and sending the temperature adjustment instruction to the temperature control device via the gas company sensor network platform and the gas device object platform.

One or more embodiments of the present disclosure provide a non-transitory computer-readable storage medium storing computer instructions, and when a computer reads the computer instructions in the storage medium, the computer may implement the method described in the embodiments.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, and wherein:

FIG. 1 is a diagram illustrating an exemplary structure of an Internet of Things (IoT) system for pipeline impurity monitoring based on an intelligent gas IoT according to some embodiments of the present disclosure;

FIG. 2 is a flowchart illustrating an exemplary method for pipeline impurity monitoring based on an intelligent gas Internet of Things according to some embodiments of the present disclosure;

FIG. 3 is a flowchart illustrating an exemplary process for determining an impurity aggregation degree according to some embodiments of the present disclosure; and

FIG. 4 is a schematic diagram illustrating an exemplary effect assessment model according to some embodiments of the present disclosure.

### DETAILED DESCRIPTION

In order to more clearly illustrate the technical solutions of the embodiments of the present disclosure, the accompanying drawings, which are to be used in the description of the embodiments, will be briefly described below. The accompanying drawings do not represent the entirety of the embodiments.

It should be understood that “system”, “device”, “unit” and/or “module” as used herein is a manner used to distinguish different components, elements, parts, sections, or assemblies at different levels. However, if other words serve the same purpose, the words may be replaced by other expressions.

The words “one”, “a”, “a kind” and/or “the” are not especially singular but may include the plural unless the context expressly suggests otherwise. In general, the terms “comprise”, “comprises”, “comprising”, “include”, “includes”, and/or “including”, merely prompt to include operations and elements that have been clearly identified, and these operations and elements do not constitute an exclusive listing. The methods or devices may also include other operations or elements.

When describing the operations performed in the embodiments of the present disclosure in terms of the steps, the order of the steps is interchangeable if not otherwise indicated, the steps may be omitted, and other steps may be included in the process of operation.

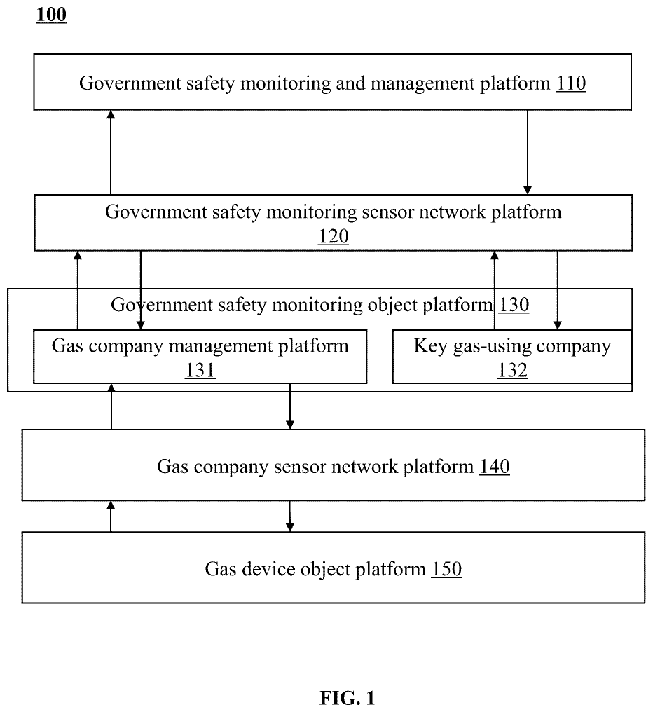

FIG. 1 is a diagram illustrating an exemplary structure of an Internet of Things (IoT) system for pipeline impurity monitoring based on an intelligent gas IoT according to some embodiments of the present disclosure.

As shown in FIG. 1, an IoT system 100 for pipeline impurity monitoring based on an intelligent gas IoT may include a government safety monitoring and management platform 110, a government safety monitoring sensor network platform 120, a government safety monitoring object platform 130, a gas company sensor network platform 140, and a gas device object platform 150.

The government safety monitoring and management platform 110 refers to a platform for information supervision and management by the government.

The government safety monitoring sensor network platform 120 refers to a platform for governmental supervision and management of sensor network information. In some embodiments, the government safety monitoring sensor network platform 120 may interact with a gas company management platform 131, a key gas-using company 132, and the government safety monitoring and management platform 110.

The government safety monitoring object platform 130 refers to a platform for generating government regulatory information and executing control information. In some embodiments, the government safety monitoring object platform 130 may include the gas company management platform 131 and the key gas-using company 132.

The gas company management platform 131 refers to a comprehensive management platform for gas company information. The key gas-using company 132 refers to a company that uses gas and needs to be focused on.

The gas company sensor network platform 140 refers to a platform that comprehensively manages sensor information of a gas company. In some embodiments, the gas company sensor network platform 140 may be configured as a communication network, a gateway, etc. In some embodiments, the gas company sensor network platform 140 may interact with the gas company management platform 131 and the gas device object platform 150.

The gas device object platform 150 refers to a functional platform for generating sensing information and executing control information.

In some embodiments, the gas device object platform 150 may further include a valve device and a temperature control device deployed at at least one pipeline connection. The pipeline connection refers to a position where two or more gas pipelines are connected. The valve device may include a pressure monitoring component and a temperature monitoring component.

The pressure monitoring component is configured to collect pressure monitoring data. In some embodiments, the pressure monitoring component may include a pressure sensor, a pressure detector, etc. The temperature monitoring component is configured to collect temperature monitoring data. In some embodiments, the temperature monitoring component may include a temperature sensor, a thermometer, etc.

In some embodiments, the frequency at which the pressure monitoring component collects the pressure monitoring data and the frequency at which the temperature monitoring component collects the temperature monitoring data may be preset based on historical experience.

The temperature control device is configured to regulate the temperature within a gas pipeline. For example, the temperature control device raises or lowers the temperature within the gas pipeline. In some embodiments, the temperature control device may include a pipe heater, an electric heater, or the like. In some embodiments, the temperature control device may be deployed on an outer wall of the pipeline at the at least one pipeline connection.

In some embodiments, the IoT system 100 for pipeline impurity monitoring based on the intelligent gas IoT may further include a processor. In some embodiments, the processor may process information and/or data related to the IT system 100 for pipeline impurity monitoring based on the intelligent gas IoT to perform one or more of the functions described in the present disclosure. In some embodiments, the processor may include a central processing unit (CPU), an application-specific integrated circuit (ASIC), an application-specific instruction processor (ASIP), a graphics processor (GPU), etc., or any combination thereof.

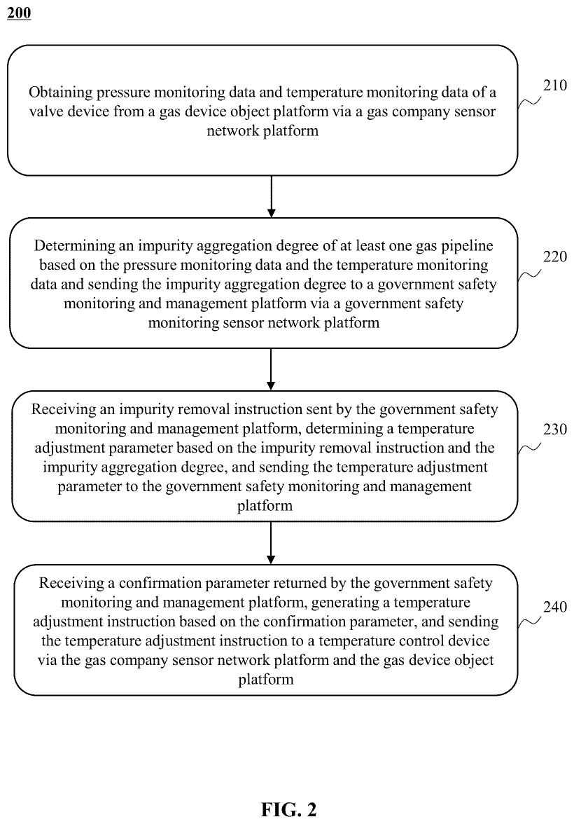

More details regarding the foregoing may be found in other contents of the present disclosure (e.g., descriptions in FIG. 2 to FIG. 4).

In some embodiments of the present disclosure, the IoT system 100 for pipeline impurity monitoring based on the intelligent gas IoT may form a closed loop of information operation among functional platforms to realize informatization and intellectualization of pipeline impurity monitoring.

FIG. 2 is a flowchart illustrating an exemplary method for pipeline impurity monitoring based on an intelligent gas IoT according to some embodiments of the present disclosure. In some embodiments, a process 200 is performed by the gas company management platform (hereinafter referred to as a management platform) of the IoT system for pipeline impurity monitoring based on the intelligent gas IoT. More details regarding various platforms of the IoT system for pipeline impurity monitoring based on the intelligent gas IoT may be found in the corresponding descriptions of FIG. 1.

As shown in FIG. 2, the process 200 includes the following operations.

In 210, pressure monitoring data and temperature monitoring data of a valve device are obtained from the gas device object platform via the gas company sensor network platform.

The pressure monitoring data refers to data obtained by monitoring a gas pressure at at least one valve device. In some embodiments, the pressure monitoring data may include a sequence consisting of gas pressures at the at least one valve device during a preset monitoring period.

The preset monitoring period refers to a time period during which the valve device is monitored. The preset monitoring period may be preset based on historical experience. For example, the preset monitoring period may be 5 min past the current time, etc. The gas pressure refers to gas pressure in the gas pipeline.

In some embodiments, the pressure monitoring data may be obtained by a pressure monitoring component. More details regarding the pressure monitoring component may be found in other contents of the present disclosure (e.g., description in connection with FIG. 1).

The temperature monitoring data refers to data obtained by monitoring the temperature at the at least one valve device. In some embodiments, the temperature monitoring data may include a sequence consisting of temperatures of the at least one valve device during the preset monitoring period.

In some embodiments, the temperature monitoring data may be obtained by the temperature monitoring component. More details regarding the temperature monitoring component may be found in other contents of the present disclosure (e.g., description in connection with FIG. 1).

In 220, an impurity aggregation degree of the at least one gas pipeline is determined based on the pressure monitoring data and the temperature monitoring data, and the impurity aggregation degree is sent to the government safety monitoring and management platform via the government safety monitoring sensor network platform.

The impurity aggregation degree refers to data that characterizes the extent to which impurities are formed and aggregated in the gas pipeline. The impurity aggregation degree may be expressed, e.g., by a numerical value. For example, the impurity aggregation degree may be expressed by numerical values of 0-1. The closer the numerical value is to 1, the higher the impurity aggregation degree is, which indicates that the likelihood of formation of impurities with qualitative changes is higher in the gas pipeline.

The impurities with qualitative changes refer to impurities that are visible to the naked eye or impurities that are capable of affecting the transportation of gas.

In some embodiments, the management platform may determine the impurity aggregation degree of the at least one gas pipeline based on the pressure monitoring data and the temperature monitoring data in a plurality of ways. For example, the management platform may determine an impurity aggregation degree of the valve device at each end of the gas pipeline based on the pressure monitoring data and the temperature monitoring data of the valve device at each end of the gas pipeline, and determine an average value of the impurity aggregation degree of the valve device at each end of the gas pipeline as the impurity aggregation degree of the gas pipeline.

In some embodiments, the impurity aggregation degree of the valve device may be correlated with a difference between the pressure monitoring data and composite pressure data, a difference between the temperature monitoring data and composite temperature data, or the like. For example, the impurity aggregation degree of the valve device may be positively correlated with the difference between the pressure monitoring data and the composite pressure data and positively correlated with the difference between the temperature monitoring data and the composite temperature data. In some embodiments, the management platform may determine the impurity aggregation degree of the valve device by a predetermined equation based on the pressure monitoring data and the temperature monitoring data of the valve device. Exemplarily, the predetermined equation may be as shown in equation (1):

$$Z = {k}_{1} * ( {W}_{1} - {W}_{s} ) + {k}_{2} * ( {Q}_{1} - {Q}_{s} ) + {k}_{3} * ( {W}_{2} - {W}_{t} ) + {k}_{4} * ( {Q}_{2} - {Q}_{t} ) \qquad ( 1 )$$

Z denotes the impurity aggregation degree of the valve device, W₁ and W₂ denote fluctuation of the pressure monitoring data and fluctuation of the temperature monitoring data, respectively, Q₁ and Q₂ denote change trend of the pressure monitoring data and change trend of the temperature monitoring data, respectively, Wₛ denotes fluctuation of the composite pressure data, Qₛ denotes change trend of the composite pressure data, Wₜ denotes fluctuation of the composite temperature data, Qₜ denotes change trend of the composite temperature data, k₁ denotes a coefficient of a difference between the fluctuation of the pressure monitoring data and the fluctuation of the composite pressure data, k₂ denotes a coefficient of a difference between the change trend of the pressure monitoring data and the change trend of the composite pressure data, k₃ denotes a coefficient of a difference between the fluctuation of the temperature monitoring data and the fluctuation of the composite temperature data, and k₄ denotes a coefficient of a difference between the change trend of the temperature monitoring data and the change trend of the composite temperature data. k₁, k₂, k₃, and k₄ may be constants of an order of magnitude and may be preset by a human being or set by default by the system.

In some embodiments, the management platform may determine the fluctuation and the change trend of the pressure monitoring data for each valve device in a plurality of ways. For example, the management platform may determine an extreme deviation, a variance, etc., of the pressure monitoring data for each valve device, and indicate the fluctuation in the pressure monitoring data by the extreme deviation, the variance, etc.

As another example, the management platform may utilize processing algorithms to obtain the change trend of the pressure monitoring data for each valve device. The processing algorithms may include, but are not limited to, linear regression algorithms, etc. Merely by way of example, for the pressure monitoring data of a certain valve device, the management platform may plot a fitted straight line thereon and determine a slope of the fitted straight line as the change trend of the pressure monitoring data corresponding to the valve device. A horizontal axis of the fitted straight line corresponds to time, and a vertical axis corresponds to gas pressure.

In some embodiments, the manner for determining the fluctuation and the change trend of the temperature monitoring data of the valve device is the same as the manner for determining the fluctuation and the change trend of the pressure monitoring data of the valve device and is not described herein.

In some embodiments, the management platform may determine an average value of pressure for each valve device in a plurality of valve devices, form the composite pressure data from the average values of pressure for the plurality of valve devices, and determine the fluctuation and the change trend of the composite pressure data. At the same time, the management platform may determine an average value of temperature for each valve device, form the composite temperature data from the average values of temperature for the plurality of valve devices, and determine the fluctuation and the change trend of the composite temperature data. The management platform may average the pressure monitoring data and the temperature monitoring data of a single valve device to obtain the average value of pressure and the average value of temperature of the valve device.

In some embodiments, the manner for determining the fluctuation and the change trend of the composite pressure data and the fluctuation and the change trend of the composite temperature data is similar to the manner for determining the fluctuation and the change trend of the pressure monitoring data and the fluctuation and the change trend of the temperature monitoring data as described above and is not described herein.

It is understood that when the fluctuation of at least one of the pressure monitoring data or the temperature monitoring data of a particular valve device is significantly different from the fluctuation of at least one of the composite pressure data or the composite temperature data, it indicates that impurities with qualitative changes may have formed, or impurities may have been generated at the position of the valve device. When the change trend of at least one of the pressure monitoring data or the temperature monitoring data of the particular valve device is different from the change trend of at least one of the composite pressure data or the composite temperature data, it indicates that at least one of the change in pressure or the change in temperature of the valve device is abnormal, and the position of the valve device may have formed impurities with qualitative changes. By determining the difference between at least one of the pressure or the temperature in a single gas pipeline and that of the entire gas network, the impurity aggregation degree in the gas pipeline may be more effectively determined.

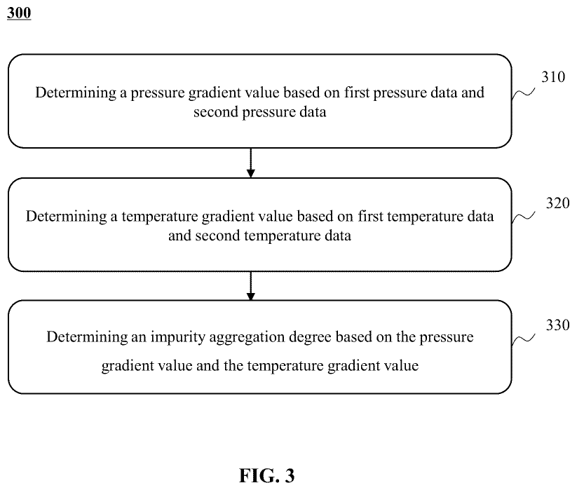

In some embodiments, the management platform may determine a pressure gradient value based on first pressure data and second pressure data, determine a temperature gradient value based on the first temperature data and the second temperature data, and determine the impurity aggregation degree based on the pressure gradient value and the temperature gradient value. More details regarding this section may be found in other contents of the present disclosure (e.g., description in connection with FIG. 3).

In 230, an impurity removal instruction sent by the government safety monitoring and management platform is received, a temperature adjustment parameter is determined based on the impurity removal instruction and the impurity aggregation degree, and the temperature adjustment parameter is sent to the government safety monitoring and management platform.

The impurity removal instruction refers to an instruction that indicates whether impurities need to be removed. In some embodiments, the impurity removal instruction may be expressed in a plurality of ways. For example, the impurity removal instruction may be expressed using a Boolean value, with 0 representing that no removal of impurities is required, and 1 representing that removal of impurities is required. As another example, the impurity removal instruction may be expressed as text, including “need to remove impurities”, “do not need to remove impurities”, or the like.

In some embodiments, the impurity removal instruction may be determined through the government safety monitoring and management platform. For example, the impurity removal instruction may be determined through a regulator of the government safety monitoring and management platform. As another example, in response to the impurity aggregation degree being greater than a removal threshold, the government safety monitoring and management platform determines the impurity removal instruction as that the impurities need to be removed. The removal threshold refers to data used to determine whether the impurities need to be removed, and the removal threshold may be set in advance based on historical experience.

The temperature adjustment parameter refers to a parameter related to regulating the operation of a temperature control device. In some embodiments, the temperature adjustment parameter may include at least one of opening time, opening temperature, or the like. The opening time may include a time point when the temperature control device is turned on, a duration, etc. The opening temperature refers to the temperature at which the temperature control device needs to go up or down.

In some embodiments, the temperature adjustment parameter may include a plurality of sets of data, each set of data may correspond to the temperature control device, and each temperature control device corresponds to a set of data.

It should be understood that when impurities are present in the gas pipeline and the impurities need to be removed, the impurities may be degraded by controlling the temperature control device to raise the temperature, so as to achieve the purpose of removing the impurities. More details regarding the temperature control device may be found in other contents of the present disclosure (e.g., description in connection with FIG. 1).

In some embodiments, in response to the impurity removal instruction received from the government safety monitoring and management platform as that impurities need to be removed (e.g., 1), the management platform may determine the temperature adjustment parameter in a plurality of ways based on the impurity removal instruction and the impurity aggregation degree. For example, for each gas pipeline in a plurality of gas pipelines, the management platform may query a parameter comparison table based on an impurity grade of the impurity aggregation degree of the gas pipeline and determine a reference adjustment parameter corresponding to the impurity grade in the parameter comparison table as the temperature adjustment parameter of the temperature control device corresponding to the gas pipeline.

In some embodiments, the management platform may determine the impurity grade of the impurity aggregation degree via an impurity grade table. The impurity grade table may include a correspondence between the impurity aggregation degree and the impurity grade. The impurity grade table may be preset based on historical experience. Exemplarily, the impurity grade table may include four or more grades corresponding to impurity aggregation degrees of 0-0.25, 0.25-0.5, 0.5-0.75, 0.75-1, or the like.

In some embodiments, the management platform may construct the parameter comparison table based on historical data. Merely by way of example, the management platform may statistically count historical impurity aggregation degrees and corresponding historical temperature adjustment parameters in the historical data as sample data and determine the sample data in which impurity removal effect meets a preset criteria as the target sample data. At the same time, the management platform may categorize the target sample data based on the impurity grade and obtain a plurality of pieces of target sample data under each impurity grade. For the plurality of pieces of target sample data under each impurity grade, the management platform may count the historical temperature adjustment parameter that appears the most times in the plurality of pieces of target sample data, use the historical temperature adjustment parameter as the reference adjustment parameter, and count the historical temperature adjustment parameter in the table to obtain the parameter comparison table, which includes a plurality of impurity grades and the reference adjustment parameter corresponding to each impurity grade.

The impurity removal effect refers to the effect of removing impurities from the gas pipeline based on the sample data. In some embodiments, the impurity removal effect may be expressed by an impurity aggregation degree after performing impurity removal. The impurity aggregation degree after performing impurity removal may be obtained by, for example, manually measuring or robotically detecting the actual impurity removal in the gas pipeline.

In some embodiments, the preset criteria may be preset based on historical experience. Exemplary preset criteria may be an impurity aggregation degree of less than 0.1.

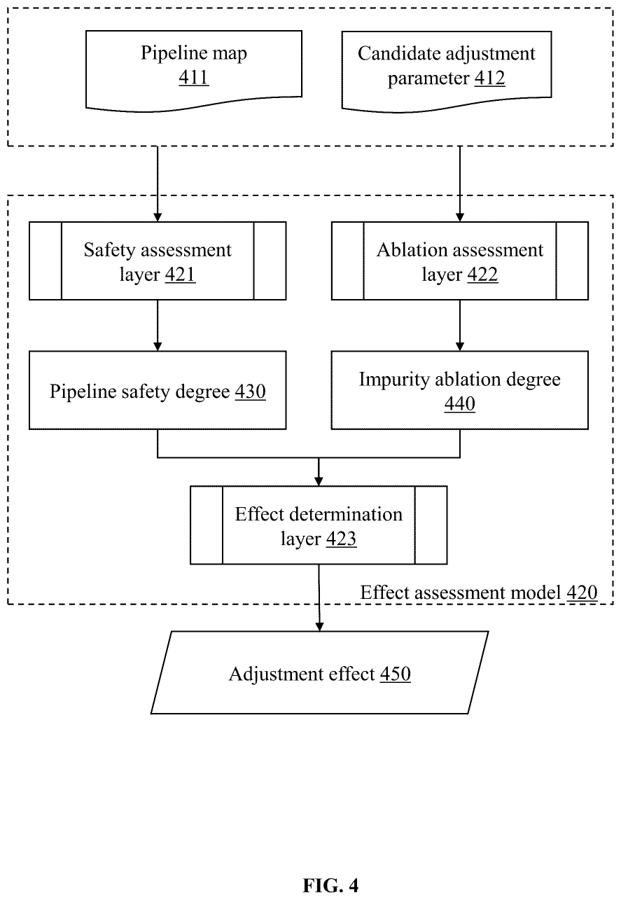

In some embodiments, the management platform may determine, based on a pipeline map and a plurality of candidate adjustment parameters, an adjustment effect of each candidate adjustment parameter among the plurality of candidate adjustment parameters through an effect assessment model and determine the temperature adjustment parameter based on the adjustment effect. More details regarding this section may be found in other contents of the present disclosure (e.g., description in connection with FIG. 4).

In 240, a confirmation parameter returned by the government safety monitoring and management platform is received, a temperature adjustment instruction is generated based on the confirmation parameter, and the temperature adjustment instruction is sent to the temperature control device via the gas company sensor network platform and the gas device object platform.

The temperature adjustment instruction refers to an instruction that controls the operation of the temperature control device.

In some embodiments, the management platform may generate the temperature adjustment instruction based on the confirmation parameter.

The confirmation parameter refers to information used to confirm the operation of the temperature control device. In some embodiments, the confirmation parameter may include at least one of whether the temperature control device is used to regulate the temperature of the pipeline for impurity removal or the temperature adjustment parameter. In some embodiments, the confirmation parameter may be issued by a supervisor of the government safety monitoring and management platform.

In some embodiments, the supervisor of the government safety monitoring and management platform may adjust the temperature adjustment parameter based on his or her judgment, obtain a new temperature adjustment parameter, and add the new temperature adjustment parameter to the confirmation parameter.

In some embodiments, in response to the confirmation parameter received by the management platform being that the temperature control device is used to adjust the temperature of the pipeline for impurity removal, the management platform may generate the temperature adjustment instruction based on the temperature adjustment parameter. In response to the confirmation parameter received by the management platform being that the temperature control device is not used to adjust the temperature of the pipeline for impurity removal, the management platform may follow a previous temperature adjustment instruction.

In some embodiments of the present disclosure, since non-gas impurities are generated in the gas pipeline, real-time and accurate monitoring of the attachment of impurities within the gas pipeline may be achieved by monitoring the pressure and the temperature of the valve device. This enables timely detection and effective handling of pipeline corrosion issues, effectively maintaining the gas transmission environment of the pipeline, ensuring the purity and normal transmission of the gas, and significantly enhancing the overall safety performance of the gas pipeline.

It should be noted that the foregoing description of the process 200 is intended to be exemplary and illustrative only and does not limit the scope of application of the present disclosure. For those skilled in the art, various corrections and changes to the process hand-eye calibration can be made under the guidance of the present disclosure. However, these corrections and changes remain within the scope of the present disclosure.

FIG. 3 is a flowchart illustrating an exemplary process for determining an impurity aggregation degree according to some embodiments of the present disclosure. In some embodiments, process 300 is performed by a management platform. As shown in FIG. 3, the process 300 includes the following operations.

In some embodiments, a pressure monitoring component may include a first pressure component and a second pressure component, and pressure monitoring data may include first pressure data and second pressure data. A temperature monitoring component may include a first temperature component and a second temperature component, and temperature monitoring data may include first temperature data and second temperature data. The management platform may determine a pressure gradient value based on the first pressure data and the second pressure data, determine a temperature gradient value based on the first temperature data and the second temperature data, and determine an impurity aggregation degree based on the pressure gradient value and the temperature gradient value.

More details regarding the pressure monitoring component and the temperature monitoring component may be found in FIG. 1 and related descriptions thereof. More details regarding the pressure monitoring data, the temperature monitoring data, and the impurity aggregation degree may be found in FIG. 2 and related descriptions thereof.

Two sides of a valve device include an upstream side and a downstream side. The upstream side of the valve device refers to a side of the valve device that receives gas. The downstream side of the valve device refers to a side of the valve device that outputs gas.

The first pressure component refers to a component that monitors gas pressure on the upstream side of the valve device. The first pressure data refers to data obtained by monitoring the gas pressure on the upstream side of the valve device. In some embodiments, the first pressure data may include a sequence consisting of the gas pressure on the upstream side of the valve device during a preset monitoring period. More details regarding the preset monitoring period may be found in FIG. 2 and related descriptions thereof.

In some embodiments, the first pressure component may be deployed on the upstream side of the valve device.

The second pressure component refers to a component that monitors gas pressure on the downstream side of the valve device. The second pressure data refers to data obtained by monitoring the gas pressure on the downstream side of the valve device. In some embodiments, the second pressure data may include a sequence consisting of the gas pressure on the downstream side of the valve device during the preset monitoring period.

In some embodiments, the second pressure component may be deployed on the downstream side of the valve device.

The first temperature component refers to a component that monitors the temperature of the upstream side of the valve device. The first temperature data refers to data obtained by monitoring the temperature of the upstream side of the valve device. In some embodiments, the first temperature data may include a sequence consisting of the temperature on the upstream side of the valve device during the preset monitoring period.

In some embodiments, the first temperature component may be deployed on the upstream side of the valve device.

The second temperature component refers to a component that monitors temperature on the downstream side of the valve device. The second temperature data refers to data obtained by monitoring the temperature of the downstream side of the valve device. In some embodiments, the second temperature data may include a sequence consisting of the temperature on the downstream side of the valve device during the preset monitoring period.

In some embodiments, the second temperature component may be deployed on the downstream side of the valve device.

In 310, the pressure gradient value may be determined based on the first pressure data and the second pressure data.

The pressure gradient value refers to data used to measure pressure changes on both sides of the valve device.

In some embodiments, the management platform may determine the pressure gradient value based on the first pressure data and the second pressure data in a plurality of ways. For example, for each valve device, the management platform may determine a difference between the first pressure data and the second pressure data to obtain pressure difference data on both sides of the valve device, determine fluctuation of the pressure difference data, and determine a difference between the fluctuation of the pressure difference data and a pressure fluctuation threshold as the pressure gradient value. The manner for determining the fluctuation of the pressure difference data is similar to the manner for determining the fluctuation of the pressure monitoring data in FIG. 2 and will not be repeated here.

The pressure fluctuation threshold refers to a critical value for the fluctuation of the gas pressure on both sides of the valve device. In some embodiments, the pressure fluctuation threshold corresponds to the valve device, with one valve device corresponding to one pressure fluctuation threshold.

In some embodiments, the pressure fluctuation threshold of a single valve device is correlated with a composite pressure fluctuation value, an average inlet-outlet difference, and an inlet-outlet difference of the valve device. For example, the pressure fluctuation threshold of the single valve device is directly proportional to the composite pressure fluctuation value and the inlet-outlet difference of the valve device, and inversely proportional to the average inlet-outlet difference. In some embodiments, the management platform may determine the pressure fluctuation threshold corresponding to the valve device based on the composite pressure fluctuation value, the inlet-outlet difference of the valve device, and the average inlet-outlet difference by a preset pressure equation. Exemplarily, the preset pressure equation may be represented by equation (2):

$${P}_{s} = {u}_{s} * v / c \qquad ( 2 )$$

Pₛ denotes the pressure fluctuation threshold, uₛ denotes the composite pressure fluctuation value, ν denotes the inlet-outlet difference of the valve device, and c denotes the average inlet-outlet difference.

The composite pressure fluctuation value refers to data used to reflect fluctuation in pressure difference data of a plurality of valve devices within a gas network. In some embodiments, the management platform may determine the pressure difference data of all valve devices, determine a standard deviation and a mean value of a plurality of pieces of pressure difference data, and determine a ratio of the standard deviation to the mean value as the composite pressure fluctuation value.

The inlet-outlet difference of the valve device refers to data characterizing a situation where there is a gap between the outlet and inlet degrees of the valve device. In some embodiments, the management platform may determine an absolute value of a difference between the in-degree and out-degree of the valve device as the inlet-outlet difference of the valve device. The in-degree refers to an amount of gas input to the valve device. The out-degree refers to an amount of gas output from the valve device.

In some embodiments, the management platform may obtain the in-degree and the out-degree of the valve device via a plurality of gas metering devices, which may be deployed on the upstream side and the downstream side of the valve device.

In some embodiments, the management platform may determine inlet-outlet differences of all valve devices within the gas pipeline network and determine an average of the plurality of inlet-outlet differences as the average inlet-outlet difference.

In 320, the temperature gradient value may be determined based on the first temperature data and the second temperature data.

The temperature gradient value refers to data used to measure the temperature changes on both sides of the valve device.

In some embodiments, the management platform may determine the temperature gradient value based on the first temperature data and the second temperature data in a plurality of ways. For example, for each valve device, the management platform may determine a difference between the first temperature data and the second temperature data to obtain temperature difference data on both sides of the valve device, determine fluctuation of the temperature difference data, and determine a difference between the fluctuation of the temperature difference data and a temperature fluctuation threshold as the temperature gradient value. The manner for determining the fluctuation of the temperature difference data is similar to the manner for determining the fluctuation of the temperature monitoring data and will not be repeated herein.

The temperature fluctuation threshold refers to a critical value for the fluctuation of temperature on both sides of the valve device. In some embodiments, the temperature fluctuation threshold for a single valve device is correlated with a composite temperature fluctuation value, the average inlet-outlet difference, the inlet-outlet difference of the valve device, and a thermal conductivity of the valve material. For example, the temperature fluctuation threshold of the single valve device is directly proportional to the composite temperature fluctuation value and the inlet-outlet difference of the valve device, and inversely proportional to the average inlet-outlet difference and the thermal conductivity of the valve material. In some embodiments, the management platform may determine the temperature fluctuation threshold corresponding to the valve device based on the composite temperature fluctuation value, the inlet-outlet difference of the valve device, the average inlet-outlet difference, and the thermal conductivity of the valve material by a preset temperature equation. Exemplarily, the preset temperature equation may be represented by equation (3):

$${P}_{t} = {u}_{t} * v / ( c * m ) \qquad ( 3 )$$

Pₜ denotes the temperature fluctuation threshold, uₜ denotes the composite temperature fluctuation value, ν denotes the inlet-outlet difference of the valve device, c denotes the average inlet-outlet difference, and m denotes the thermal conductivity of the valve material.

The composite temperature fluctuation value refers to data used to reflect the fluctuation in the temperature difference data of the plurality of valve devices within the gas pipeline network. In some embodiments, the manner for determining the composite temperature fluctuation value is similar to the manner for determining the composite pressure fluctuation value, which is not described herein.

The thermal conductivity of the valve material refers to a physical quantity that characterizes the thermal conductivity of the material used to manufacture the valve device. The management platform may obtain the thermal conductivity of the valve material through the government safety monitoring and management platform.

In 330, the impurity aggregation degree may be determined based on the pressure gradient value and the temperature gradient value.

In some embodiments, the management platform may determine the impurity aggregation degree of at least one gas pipeline in a plurality of ways based on the pressure gradient value and the temperature gradient value. For example, the management platform may first determine, based on the pressure gradient value and the temperature gradient value, the impurity aggregation degree of the valve device at each end of the gas pipeline, and determine an average of the impurity aggregation degree of the valve device at each end of the gas pipeline as the impurity aggregation degree of the gas pipeline.

In some embodiments, the impurity aggregation degree of the valve device is correlated with the pressure gradient value and the temperature gradient value. For example, the impurity aggregation degree of the valve device may be positively correlated with the pressure gradient value and the temperature gradient value. In some embodiments, the management platform may determine the impurity aggregation degree of the valve device based on the pressure fluctuation threshold and the temperature fluctuation threshold by a preset aggregation equation. Exemplarily, the preset aggregation equation may be represented by equation (4):

$$Z = {k}_{5} * {P}_{s} + {k}_{6} * {P}_{t} \qquad ( 4 )$$

Z denotes the impurity aggregation degree of the valve device, Pₛ denotes the pressure fluctuation threshold, Pₜ denotes the temperature fluctuation threshold, and k₅, and k₆ denote a coefficient of the pressure fluctuation threshold and a coefficient of the temperature fluctuation threshold, respectively. k₅, and k₆ may be constants of an order of magnitude and may be preset by a human being or set by default by the system.

In some embodiments, the valve device further includes a flow adjustment component and a pressure adjustment component. The management platform may determine the impurity aggregation degree based on a flow adjustment accuracy of the flow adjustment component, a pressure adjustment accuracy of the pressure adjustment component, the temperature gradient value, and the pressure gradient value.

The flow adjustment component refers to a component used to regulate the gas flow rate in the gas pipeline, such as a flow restriction valve, a flow restriction orifice plate, or the like. The gas flow rate refers to the volume of gas flowing through the gas pipeline per unit of time, e.g., 100 m³/h, or the like.

The flow adjustment accuracy refers to the adjustment sensitivity of the flow adjustment component. For example, the flow adjustment accuracy may be as high as 0.01.

The pressure adjustment component refers to a component configured to regulate the pressure of the gas in the gas pipeline, such as a pressure regulator.

The pressure adjustment accuracy refers to the adjustment sensitivity of the pressure adjustment component, for example, the pressure adjustment accuracy may be as high as 0.01.

In some embodiments, the management platform may obtain the flow adjustment accuracy and the pressure adjustment accuracy via the gas device object platform. The gas device object platform may obtain and store the flow adjustment accuracy and the pressure adjustment accuracy via, for example, user input.

In some embodiments, the management platform may determine the impurity aggregation degree based on the flow adjustment accuracy, the pressure adjustment accuracy, the temperature gradient value, and the pressure gradient value in a plurality of ways. For example, the management platform may construct a target feature vector based on the flow adjustment accuracy, the pressure adjustment accuracy, the temperature gradient value, and the pressure gradient value, match a reference vector that satisfies a preset matching condition with the target feature vector in a vector database, and determines labels of the reference vector that satisfies the preset matching condition as the impurity aggregation degree. The target feature vector may be a feature vector constructed based on the flow adjustment accuracy, the pressure adjustment accuracy, the temperature gradient value, and the pressure gradient value. In some embodiments, the preset matching condition may include vector similarity being the highest. The vector similarity is negatively correlated with a vector distance, which may include an Euclidean distance, a cosine distance, or the like.

In some embodiments, the vector database may be preset based on historical data. The vector database may include a plurality of reference vectors and a label for each reference vector.

In some embodiments, the management platform may construct a clustering vector based on historical samples and actual impurity aggregation degrees in the gas pipeline corresponding to the historical samples, cluster a plurality of clustering vectors, and construct the reference vector based on a historical sample corresponding to a cluster center formed by clustering, and determine the actual impurity aggregation degree corresponding to the cluster center as the label of the reference vector. The historical samples refer to a set of historical flow adjustment accuracy, historical pressure adjustment accuracy, historical temperature gradient value, and historical pressure gradient value in the historical data.

In some embodiments, the actual impurity aggregation degree may be determined by a plurality of experiments. For example, the technician may extract and analyze the gas in the gas pipeline to obtain an experimental gas, conduct the plurality of experiments based on the experimental gas, count a count of experiments in which the impurities are agglomerated over the plurality of experiments, and determine a ratio of the count of the experiments in which impurities are agglomerated to a total count of experiments as the actual impurity aggregation degree. The composition of the experimental gas is consistent with the composition of the gas in the extracted gas pipeline. The process of the experiment may include injecting the experimental gas into the simulated gas pipeline environment for the experiment and observing whether the simulated gas pipeline environment is free of condensed impurities.

Exemplarily, the technician performs 100 experiments based on the experimental gas and counts the count of experiments in which the impurities are condensed over the plurality of experiments to be 90, then an actual impurity aggregation degree is 0.9.

In some embodiments of the present disclosure, by considering the adjustment accuracy of the flow adjustment component and the pressure adjustment component, the potential systematic errors caused by these two components are considered. By considering the systematic errors when determining the impurity aggregation degree, the accuracy of determining the impurity aggregation degree can be further improved.

In some embodiments, the management platform may determine the impurity aggregation degree by an aggregation prediction model based on the flow adjustment accuracy, the pressure adjustment accuracy, the temperature gradient value, and the pressure gradient value.

The aggregation prediction model refers to a model for determining the impurity aggregation degree. In some embodiments, the aggregation prediction model may be a machine learning model. For example, the aggregation prediction model may include any one or a combination of a convolutional neural network (CNN) model, a neural network (NN) model, or other customized model structure.

In some embodiments, the management platform may train the aggregation prediction model based on a training sample set via a gradient descent algorithm, or the like. The training sample set includes a plurality of training samples with labels. Each set of training samples of the training sample set may include a sample flow adjustment accuracy, a sample pressure adjustment accuracy, a sample temperature gradient value, and a sample pressure gradient value. The labels of each set of training samples may be the actual impurity aggregation degree. In some embodiments, the training samples and the labels may be obtained based on historical data. More details regarding the actual impurity aggregation degree may be found in the related descriptions hereinabove.

In some embodiments, the aggregation prediction model may be trained by inputting a plurality of training samples with labels into an initial aggregation prediction model, constructing a first loss function by the labels and prediction results of the initial aggregation prediction model, iteratively updating the initial aggregation prediction model based on the first loss function, and completing the training of the aggregation prediction model when the first loss function of the initial aggregation prediction model satisfies a first preset condition. The first preset condition includes the first loss function converging, a count of iterations reaching a threshold, or the like.

In some embodiments, a learning rate of the plurality of training samples may be correlated to a historical accident frequency of the plurality of training samples. For example, the learning rate of the plurality of training samples may be negatively correlated to the historical accident frequency, the higher the historical accident frequency, the smaller the learning rate of the plurality of training samples.

The historical accident frequency refers to the frequency of historical accidents. The historical accidents refer to pipeline accidents due to impurities in the gas pipeline, e.g., clogging, pipeline deformation, etc.

In some embodiments, the management platform may determine the gas pipeline corresponding to the training sample and determine a ratio of a count of historical accidents that occurred in the gas pipeline during a preset period to the duration of the preset period as the historical accident frequency of the training sample. The preset period may be preset based on historical experience.

In some embodiments of the present disclosure, the greater the historical accident frequency, the more historical accidents caused by impurities in the gas pipeline, and the greater the impact of impurities on the gas pipeline. Thus, reducing the learning rate of such training samples can make the aggregation prediction model converge more slowly and learn the implicit laws of such training samples better.

In some embodiments of the present disclosure, the flow adjustment accuracy, the pressure adjustment accuracy, the temperature gradient value, and the pressure gradient value are processed by the aggregation prediction model, which may utilize the self-learning capability of the machine learning model to find a law from a large amount of data, to improve the accuracy and efficiency of determining the impurity aggregation degree.

In some embodiments of the present disclosure, determining the impurity aggregation degree by the pressure gradient value and the temperature gradient value, the pressure and temperature changes upstream and downstream of the valve may be considered when determining the impurity aggregation degree. This allows for a more accurate determination of the impurity aggregation degree that closely reflects the actual conditions of the environment of the valve.

It should be noted that the foregoing description of the process 300 is intended to be exemplary and illustrative only and does not limit the scope of application of the present disclosure. For those skilled in the art, various corrections and changes to the process hand-eye calibration can be made under the guidance of the present disclosure. However, these corrections and changes remain within the scope of the present disclosure.

FIG. 4 is a schematic diagram illustrating an exemplary effect assessment model according to some embodiments of the present disclosure.

In some embodiments, the management platform may determine, based on a pipeline map 411 and a plurality of candidate adjustment parameters 412, an adjustment effect 450 of each candidate adjustment parameter among the plurality of candidate adjustment parameters through an effect assessment model 420 and determine a temperature adjustment parameter based on the adjustment effect 450. More details regarding the temperature adjustment parameter may be found in operation 230 and its associated description.

The adjustment effect refers to data characterizing the effect of the temperature control device in removing impurities from the gas pipeline after warming or cooling the gas pipeline based on the candidate adjustment parameters. In some embodiments, the adjustment effect may be expressed by a numerical value, etc., such as a value from 0-1, etc. The larger the numerical value, the better the adjustment effect.

The pipeline map refers to a graph structure that characterizes an associative relationship between the valve device and the temperature control device. The graph structure refers to a data structure consisting of nodes and edges, where edges connect nodes, and nodes and edges may have features.

In some embodiments, the management platform may construct the pipeline map based on a connection relationship between the temperature control device and the valve device in the gas pipeline network. The nodes of the pipeline map may include the valve device and the temperature control device. The features of the nodes of the valve device may include the pressure monitoring data and the temperature monitoring data, and the features of the node of the temperature control device may include the temperature adjustment parameter corresponding to the temperature control device.

The edges of the pipeline map may characterize connectivity between the nodes. In some embodiments, the edges of the pipeline map may include gas pipelines connected between the nodes. Features of the edges may include a length of the gas pipeline, an edge type, and an impurity aggregation degree. The edge type refers to a type of gas pipeline connected between the nodes. The edge type may include gas pipelines between the temperature control devices, gas pipelines between the valve devices, and gas pipelines between the valve devices and the temperature control devices. The length of the gas pipeline may be obtained via the management platform.

The candidate adjustment parameters refer to temperature adjustment parameters to be determined.

In some embodiments, the management platform may determine the plurality of candidate adjustment parameters in a plurality of ways. For example, the management platform may count the temperature adjustment parameters adopted in the historical data, sort the temperature adjustment parameters in descending order based on a count of adoption times, and determine a preset count of temperature adjustment parameters with a higher sorting as the plurality of candidate adjustment parameters.

In some embodiments, the preset count may be related to the amount of computing resources. For example, the preset count may be positively correlated to the amount of computing resources, with the greater the amount of computing resources, the greater the preset count. The computing resources refer to resources associated with the management platform for computing. In some embodiments, the computing resources may include at least one of storage resources, network resources, or the like. In some embodiments, the management platform may count its own computing resources.

In some embodiments, the management platform may determine the plurality of candidate adjustment parameters through a frequent item database.

The frequent item database refers to a database that includes a plurality of frequent items and support corresponding to each frequent item. The frequent items refer to the temperature adjustment parameters that are frequently used in historical data. The support is used to characterize the reliability of the frequent items.

In some embodiments, the frequent item database may be preset based on historical data. For example, the management platform may determine a positive sample database and a negative sample database based on the historical data, count a count of times n that a single temperature adjustment parameter in the historical data is in the positive sample database and a count of times m that it is in the negative sample database, determine the temperature adjustment parameter with n greater than a first threshold and m less than a second threshold as a frequent term, and note n/m as the support of the frequent term. The management platform may determine a plurality of frequent items and the support corresponding to each frequent item in the above manner. The first threshold and the second threshold may be set in advance based on historical experience.

In some embodiments, the management platform may screen the temperature adjustment parameters in the historical data whose adjustment differences satisfy a positive screening condition to be added to the positive sample database as positive samples. The positive screening condition may include the adjustment difference being greater than a third threshold. The adjustment difference refers to a difference between an impurity aggregation degree before the temperature control device performs the conditioning and an impurity aggregation degree after the conditioning.

In some embodiments, the third threshold may be preset based on historical experience. The management platform may also count a plurality of adjustment differences in the historical data, sort the plurality of adjustment differences in a descending order, and determine the adjustment differences that are sorted into a preset upper decile as the third threshold. The preset upper decile may be determined based on a count of the adjustment differences, e.g., the more the count of the adjustment differences, the larger the preset upper decile may be. Exemplarily, the preset upper decile may include an upper quartile, an upper quintile, etc. The upper quintile is larger than the upper quartile, with the upper quintile representing data located in the top 25% of the rankings of the adjustment differences and the upper quintile representing data located in the top 20% of the rankings of the adjustment differences.

In some embodiments, the management platform may screen the temperature adjustment parameters in the historical data whose adjustment differences satisfy a negative screening condition to be added as negative samples to the negative sample database. The negative screening condition may include the adjustment difference being less than a fourth threshold.

In some embodiments, the fourth threshold may be preset based on historical experience. The management platform may also count the plurality of adjustment differences in the historical data, sort the plurality of adjustment differences in a descending order, and determine the adjustment differences that are sorted into a preset lower decile as the fourth threshold. The preset lower decile may be determined based on the count of the adjustment differences, e.g., the larger the count of the adjustment differences, the larger the preset lower decile may be. Exemplarily, the preset lower decile may include a lower quartile, a lower quintile, etc. The lower quintile is greater than the lower quartile, with the lower quintile representing data located in the bottom 25% of the ranking of the adjustment differences and the lower quintile representing data located in the bottom 20% of the ranking of the adjustment differences.

In some embodiments, the management platform may sort the frequent items in the frequent item database in descending order according to the support, and select a top-ranked preset candidate count of the frequent items as the plurality of candidate adjustment parameters.

In some embodiments, a count of the plurality of candidate adjustment parameters may be correlated to the historical accident frequency. For example, the count of the plurality of candidate adjustment parameters may be positively correlated to the historical accident frequency. The historical accident frequency may be an average of the historical accident frequencies of all gas pipelines in the gas network. More details regarding the historical accident frequency may be found in operation 330 and its associated descriptions.

In some embodiments of the present disclosure, since many of the temperature adjustment parameters in the existing historical data may not be optimal, the issue of impurity degradation is not effectively resolved through the use of temperature adjustment parameters. Thus, by determining the plurality of candidate adjustment parameters, the temperature adjustment parameter that has the best effect may be found from a wider range of temperature adjustment parameters.

In some embodiments of the present disclosure, a temperature adjustment parameter, which has a better adjustment effect and is used more often in the historical data, is determined as the candidate adjustment parameter, which is conducive to finding the temperature adjustment parameter with the optimal adjustment effect more easily.

The effect assessment model refers to a model for determining the adjustment effect of the candidate adjustment parameter. In some embodiments, the effect assessment model may be a machine learning model. For example, the effect assessment model may include any one or a combination of a graph neural network (GNN) model, a neural network (NN) model, or other customized model structure.

In some embodiments, the management platform may train the effect assessment model based on a plurality of adjustment training samples with adjustment labels via a gradient descent algorithm, or the like. The adjustment training samples may include a sample pipeline map and a plurality of sample candidate adjustment parameters, and the adjustment labels may be actual adjustment effects. In some embodiments, the adjustment training samples may be obtained based on historical data. The sample pipeline map may include a historical pipeline map determined based on the historical data, and nodes of the historical pipeline map and features of the nodes, edges of the historical pipeline map and features of the edges are similar to those described above for the pipeline map. The training process of the effect assessment model is similar to the training process of the aggregation prediction model, which is not described herein.

In some embodiments, the management platform may count impurity aggregation degrees of all gas pipelines in the sample pipeline map and compose a historical impurity sequence based on the impurity aggregation degrees. At the same time, the management platform may count actual impurity aggregation degrees of all gas pipelines and compose an actual impurity sequence based on the impurity aggregation degrees. The management platform may further determine a difference between each piece of data in the historical impurity sequence and the corresponding data in the actual impurity sequence to obtain a result sequence. In response to a count of positive values in the result sequence being greater than a label threshold, the management platform may determine a similarity value between the impurity sequence and the actual impurity sequence and determine a difference between value 1 and the similarity value as an adjustment label. The similarity value may include a cosine similarity. The label threshold may be preset based on historical experience. For example, if more than half of the gas pipelines in the sample pipeline map are predicted to have reduced the impurity aggregation degrees, the label threshold may be 50%.

The similarity value between each piece of data in the historical impurity sequence and the corresponding data in the actual impurity sequence may be used to characterize the similarity between the actual impurity sequence and the historical impurity sequence. The greater the similarity, the more similar the situation is before and after impurity removal, the poorer the actual adjustment effect.

In some embodiments, in response to the count of positive values in the result sequence not being greater than the label threshold, the adjustment label may be −1. The value of −1 here holds no actual significance and merely represents the worst adjustment effect in practice.

In some embodiments, the effect assessment model 420 may include a safety assessment layer 421, an ablation assessment layer 422, and an effect determination layer 423.

In some embodiments, the safety assessment layer 421, the ablation assessment layer 422, and the effect determination layer 423 may be trained separately.

The safety assessment layer 421 is used to determine a pipeline safety degree 430 of each edge in the pipeline map.

In some embodiments, the management platform may input the pipeline map and the plurality of candidate adjustment parameters into the safety assessment layer to determine the pipeline safety degree of each edge of the pipeline map under the plurality of candidate adjustment parameters.

The pipeline safety degree 430 may be used to measure the safety risk of temperature adjustment for each gas pipeline in the pipeline map. In some embodiments, the pipeline safety degree may be expressed by a numerical value, or the like. For example, the pipeline safety degree may be expressed by a value from 0-1, and the closer to 1, the lower the safety risk of each gas pipeline.

In some embodiments, the management platform may input adjustment training samples with safety labels into an initial safety assessment layer, construct a second loss function from the safety labels and prediction results of the initial safety assessment layer, iteratively update the initial safety assessment layer based on the second loss function, and complete the training of the safety assessment layer when the second loss function of the initial safety assessment layer satisfies a second preset condition. The second preset condition includes the second loss function converging, a count of iterations reaching a threshold, or the like.

In some embodiments, the safety labels may be obtained based on manual labeling. For example, the safety labels may be a ratio of value 1 to a count of subsequent actual historical accidents corresponding to the adjustment training samples. If the count of subsequent actual historical accidents is 0, the safety label is 1.

The ablation assessment layer 422 is used to determine an impurity ablation degree 440 of each candidate adjustment parameter among the plurality of candidate adjustment parameters. In some embodiments, the management platform may input the pipeline map and the plurality of candidate adjustment parameters into the ablation assessment layer to determine the impurity ablation degree of each edge of the pipeline map under the plurality of candidate adjustment parameters.

The impurity ablation degree 440 may be used to measure the rate at which impurities are ablated. In some embodiments, the impurity ablation degree may be expressed by a numerical value, or the like, e.g., the larger the value, the faster the impurities are ablated.

In some embodiments, the management platform may input adjustment training samples with ablation labels into an initial ablation assessment layer, construct a third loss function from the ablation labels and prediction results of the initial ablation assessment layer, iteratively update initial ablation assessment layer based on the third loss function, and complete the training of the initial ablation assessment layer when the third loss function of the initial ablation assessment layer satisfies a third preset condition. The third preset condition includes the third loss function converging, a count of iterations reaching a threshold, or the like.

In some embodiments, the ablation labels may be actual impurity degradation rates corresponding to the adjustment training samples. The actual impurity degradation rates may be obtained by manual measurement, or the like. The impurity degradation rate may be a ratio of the amount of impurities degraded to the time taken for impurity degradation.

The effect determination layer 423 is used to determine an adjustment effect of each candidate adjustment parameter among the plurality of candidate adjustment parameters. In some embodiments, the management platform may input a pipeline map with each edge labeled with the pipeline safety degree and the impurity ablation degree into the effect determination layer to determine the adjustment effect of each candidate adjustment parameter among the plurality of candidate adjustment parameters.

In some embodiments, the management platform may, based on the output results of the initial safety assessment layer and the initial ablation assessment layer, label the pipeline safety degree and the impurity ablation degree for each edge of the sample pipeline map in the adjustment training samples, input the adjustment training samples with adjustment labels into an initial effect determination layer, construct a fourth loss function from the adjustment labels and prediction results of the initial effect determination layer, iteratively update the initial effect determination layer based on the fourth loss function, and complete the training of the effect determination layer when the fourth loss function of the initial effect determination layer satisfies a fourth preset condition. The fourth preset condition includes the fourth loss function converging, a count of iterations reaching a threshold, or the like.

In some embodiments of the present disclosure, the pipeline map is improved through the safety assessment layer and the ablation assessment layer, so that the pipeline map can have more effective information, thereby obtaining a more comprehensive adjustment effect through the effect determination layer, which is favorable for determining the optimal candidate adjustment parameter.

In some embodiments, the management platform may, based on the adjustment effect of each candidate adjustment parameter among the plurality of candidate adjustment parameters, determine the candidate adjustment parameter corresponding to the adjustment effect with the largest value as the temperature adjustment parameter.

In some embodiments of the present disclosure, by constructing the pipeline map capable of well describing the structural features of the gas pipeline network and considering the topology under the entire gas pipeline network, the efficiency and accuracy of determining the adjustment effect can be effectively improved by the effect assessment model, which is conducive to determining the optimal temperature adjustment parameter.

Some embodiments of the present disclosure further provide a non-transitory computer-readable storage medium storing computer instructions. When a computer reads the computer instructions in the storage medium, the computer executes the method described in any of the above embodiments.

In addition, certain features, structures, or characteristics of one or more embodiments of the present disclosure may be suitably combined.

In the event of any inconsistency or conflict between the descriptions, definitions, and/or the use of terms in the materials cited in the present disclosure and those described in the present disclosure, the descriptions, definitions, and/or the use of terms in the present disclosure shall prevail.

What is claimed is:

1. An Internet of Things (IoT) system for pipeline impurity monitoring based on an intelligent gas IoT, wherein the IoT system includes a government safety monitoring and management platform, a government safety monitoring sensor network platform, a government safety monitoring object platform, a gas company sensor network platform, and a gas device object platform;
the gas device object platform includes a valve device and a temperature control device deployed at at least one pipeline connection, and the valve device includes a pressure monitoring component and a temperature monitoring component;
the government safety monitoring object platform includes a gas company management platform and a key gas-using company; and
the gas company management platform is configured to:
obtain pressure monitoring data and temperature monitoring data of the valve device from the gas device object platform via the gas company sensor network platform;
determine an impurity aggregation degree of at least one gas pipeline based on the pressure monitoring data and the temperature monitoring data and send the impurity aggregation degree to the government safety monitoring and management platform via the government safety monitoring sensor network platform;
receive an impurity removal instruction sent by the government safety monitoring and management platform, determine a temperature adjustment parameter based on the impurity removal instruction and the impurity aggregation degree, and send the temperature adjustment parameter to the government safety monitoring and management platform; and
receive a confirmation parameter returned by the government safety monitoring and management platform, generate a temperature adjustment instruction based on the confirmation parameter, and send the temperature adjustment instruction to the temperature control device via the gas company sensor network platform and the gas device object platform.

2. The IoT system of claim 1, wherein the pressure monitoring component includes a first pressure component and a second pressure component, and the pressure monitoring data includes first pressure data and second pressure data; the temperature monitoring component includes a first temperature component and a second temperature component, and the temperature monitoring data includes first temperature data and second temperature data; and the gas company management platform is further configured to:
determine a pressure gradient value based on the first pressure data and the second pressure data;
determine a temperature gradient value based on the first temperature data and the second temperature data; and
determine the impurity aggregation degree based on the pressure gradient value and the temperature gradient value.

3. The IoT system of claim 2, wherein the valve device further includes a flow adjustment component and a pressure adjustment component, and the gas company management platform is further configured to:
determine the impurity aggregation degree based on a flow adjustment accuracy of the flow adjustment component, a pressure adjustment accuracy of the pressure adjustment component, the temperature gradient value, and the pressure gradient value.

4. The IoT system of claim 3, wherein the gas company management platform is further configured to:
determine, based on the flow adjustment accuracy, the pressure adjustment accuracy, the temperature gradient value, and the pressure gradient value, he impurity aggregation degree by an aggregation prediction model, the aggregation prediction model being a machine learning model.

5. The IoT system of claim 4, wherein the gas company management platform is further configured to:
train the aggregation prediction model by a plurality of training samples with labels in a training sample set, a learning rate of the plurality of training samples correlating to a historical accident frequency of the plurality of training samples.

6. The IoT system of claim 1, wherein the gas company management platform is further configured to:
determine, based on a pipeline map and a plurality of candidate adjustment parameters, an adjustment effect of each candidate adjustment parameter among the plurality of candidate adjustment parameters through an effect assessment model, the effect assessment model being a machine learning model; and
determine the temperature adjustment parameter based on the adjustment effect.

7. The IoT system of claim 6, wherein the effect assessment model includes a safety assessment layer, an ablation assessment layer, and an effect determination layer; and the gas company management platform is further configured to:
determine, based on the pipeline map and the plurality of candidate adjustment parameters, pipeline safety degrees corresponding to the plurality of candidate adjustment parameters through the safety assessment layer;
determine, based on the pipeline map and the plurality of candidate adjustment parameters, impurity ablation degrees corresponding to the plurality of candidate adjustment parameters through the ablation assessment layer; and
determine, based on the impurity ablation degrees and the pipeline safety degrees corresponding to the plurality of candidate adjustment parameters, an adjustment effect of each candidate adjustment parameter among the plurality of candidate adjustment parameters through the effect determination layer.

8. The IoT system of claim 6, wherein the gas company management platform is further configured to:
determine the plurality of candidate adjustment parameters through a frequent item database.

9. The IoT system of claim 8, wherein a count of the plurality of candidate adjustment parameters correlates to a historical accident frequency.

10. A method for pipeline impurity monitoring based on an intelligent gas Internet of Things (IoT), wherein the method is executed by a gas company management platform of an IoT system for pipeline impurity monitoring based on an intelligent gas IoT, and the method comprises:
obtaining pressure monitoring data and temperature monitoring data of a valve device from a gas device object platform via a gas company sensor network platform;
determining an impurity aggregation degree of at least one gas pipeline based on the pressure monitoring data and the temperature monitoring data and sending the impurity aggregation degree to a government safety monitoring and management platform via a government safety monitoring sensor network platform;
receiving an impurity removal instruction sent by the government safety monitoring and management platform, determining a temperature adjustment parameter based on the impurity removal instruction and the impurity aggregation degree, and sending the temperature adjustment parameter to the government safety monitoring and management platform; and
receiving a confirmation parameter returned by the government safety monitoring and management platform, generating a temperature adjustment instruction based on the confirmation parameter, and sending the temperature adjustment instruction to the temperature control device via the gas company sensor network platform and the gas device object platform.

11. The method of claim 10, wherein the determining an impurity aggregation degree of at least one gas pipeline based on the pressure monitoring data and the temperature monitoring data includes:
determining a pressure gradient value based on first pressure data and second pressure data;
determining a temperature gradient value based on first temperature data and second temperature data; and
determining the impurity aggregation degree based on the pressure gradient value and the temperature gradient value.

12. The method of claim 11, wherein the determining the impurity aggregation degree based on the pressure gradient value and the temperature gradient value includes:
determining the impurity aggregation degree based on a flow adjustment accuracy of a flow adjustment component, a pressure adjustment accuracy of a pressure adjustment component, the temperature gradient value, and the pressure gradient value.

13. The method of claim 12, wherein the determining the impurity aggregation degree based on a flow adjustment accuracy of a flow adjustment component, a pressure adjustment accuracy of a pressure adjustment component, the temperature gradient value, and the pressure gradient value includes:
determining the impurity aggregation degree by an aggregation prediction model based on the flow adjustment accuracy, the pressure adjustment accuracy, the temperature gradient value, and the pressure gradient value, the aggregation prediction model being a machine learning model.

14. The method of claim 13, wherein the method further comprises:
training the aggregation prediction model by a plurality of training samples with labels in a training sample set, a learning rate of the plurality of training samples correlating to a historical accident frequency of the plurality of training samples.

15. The method of claim 10, wherein the method further comprises:
determining, based on a pipeline map and a plurality of candidate adjustment parameters, an adjustment effect of each candidate adjustment parameter among the plurality of candidate adjustment parameters through an effect assessment model, the effect assessment model being a machine learning model; and
determining the temperature adjustment parameter based on the adjustment effect.

16. The method of claim 15, wherein the effect assessment model includes a safety assessment layer, an ablation assessment layer, and an effect determination layer; and the method further comprises:
determining, based on the pipeline map and the plurality of candidate adjustment parameters, pipeline safety degrees corresponding to the plurality of candidate adjustment parameters through the safety assessment layer;
determining, based on the pipeline map and the plurality of candidate adjustment parameters, impurity ablation degrees corresponding to the plurality of candidate adjustment parameters through the ablation assessment layer; and
determining, based on the impurity ablation degrees and the pipeline safety degrees corresponding to the plurality of candidate adjustment parameters, an adjustment effect of each candidate adjustment parameter among the plurality of candidate adjustment parameters through the effect determination layer.

17. The method of claim 15, wherein the method further includes:
determining the plurality of candidate adjustment parameters through a frequent item database.

18. The method of claim 17, wherein a count of the plurality of candidate adjustment parameters correlates to a historical accident frequency.

19. A non-transitory computer-readable storage medium storing computer instructions, wherein when a computer reads the computer instructions in the storage medium, the computer implements the method of claim 10.
